(19) United States
(12) Patent Application Publication
(10) Pub. No.: US 2016/0243843 A1
(43) Pub. Date: Aug. 25, 2016

(54) INK CARTRIDGE AND INK-JET PRINTER HAVING THE SAME

(71) Applicant: RISO KAGAKU CORPORATION, Tokyo (JP)

(72) Inventor: Tomoyuki AKIYAMA, Ibaraki (JP)

(73) Assignee: RISO KAGAKU CORPORATION, Tokyo (JP)

(21) Appl. No.: 15/048,288

(22) Filed: Feb. 19, 2016

(30) Foreign Application Priority Data
Feb. 24, 2015 (JP) 2015-034010

(51) Int. Cl. B41J 2/175

(52) U.S. Cl. CPC B41J 2/17543

(57) ABSTRACT

A processor acquires elapsed time information held by an ink cartridge loaded in an ink cartridge attachment unit, calculates current ink physical property information based on the acquired elapsed time information, and controls an ink ejection operation by an ink-jet head based on the calculated physical property information.

### CROSS REFERENCE TO RELATED APPLICATION

This application is based upon and claims the benefit of priority from the prior Japanese Patent Application No. 2015-034010, filed on Feb. 24, 2015, the entire contents of which are incorporated herein by reference.

### BACKGROUND

1. Technical Field

The present disclosure relates to an ink cartridge capable of storing and holding information on ink, and an ink-jet printer capable of using the stored and held information on the ink with the ink cartridge detachably attached to the ink-jet printer.

2. Related Art

A printer of an ink-jet type or the like uses an ink cartridge detachably attached to a main body of the printer in order to feed an image formation unit with ink. In such an ink-jet printer, the cartridge of each color needs to be replaced timely in response to exhaustion of the ink of the color. Here, even being of the same kind, the ink in the cartridge varies among lots, and thus varies in physical properties such as specific weight, viscosity and surface tension. Therefore, in an ink-jet printer described in Japanese Patent Application Publication No. 2009-56671, a drive waveform (such as a voltage or a waveform) to be applied to the ink-jet head is controlled based on tag information (such as information on the physical properties of the ink, or ejection waveform information corresponding to the physical properties) provided in the cartridge.

### SUMMARY

Meanwhile, the ink used in the ink-jet printer generally has a characteristic in that the physical properties of the ink, such as ink viscosity, change with time. FIG. 1 is a graph showing a change in ink viscosity with time. In FIG. 1, as time passes, the ink viscosity is reduced, and consequently has a large viscosity difference from the viscosity immediately after ink replacement. Note that, although FIG. 1 shows the case where the ink viscosity is reduced with time, there is also a case where the ink viscosity is increased with time.

As in the ink-jet printer described in Japanese Patent Application Publication No. 2009-56671, drive control of the ink-jet printer may be performed based on the tag information of the ink immediately after the replacement of the ink cartridge. As time passes, however, such drive control deviates from the drive control suitable for the physical properties of the ink. This leads to the occurrence of an ejection failure such as increase and decrease in ejection amount and transfer contamination, and eventually results in deterioration of image quality.

Note that, besides ink ejection control, control considering the physical properties of the ink is also performed in maintenance processing including purging processing to remove ink inside ejection ports by ejection and suction and wiping processing to remove ink adhering around the ejection ports, and also in ink circulation processing to circulate the ink within an ink path. The same problem occurs in such drive controls.

It is an object of the present disclosure to provide an ink-jet printer capable of optimally controlling operations after ink replacement in response to a temporal change in ink, and to provide an ink cartridge used therein.

An ink-jet printer in some embodiments includes: an ink cartridge attachment unit; an ink cartridge attachable to and detachable from the ink cartridge attachment unit, and configured to store ink to be fed to the ink-jet printer and store elapsed time information on a time elapsed since manufacture of the stored ink; an ink-jet head having a nozzle and configured to eject the ink stored in the ink cartridge through the nozzle and form an image on a paper; and a processor configured to acquire the elapsed time information held by the ink cartridge loaded in the ink cartridge attachment unit, calculate current ink physical property information based on the acquired elapsed time information, and control an ink ejection operation by the ink-jet head based on the calculated physical property information.

According to the above configuration, the ink cartridge holds the elapsed time information on the time elapsed since manufacture of the stored ink, and the processor acquires the elapsed time information and controls the ink ejection operation in the ink-jet head based on the acquired elapsed time information. Thus, when an increase in ink viscosity with time makes it difficult for the ink to be ejected from the nozzles, the ejection amount can be increased by increasing the drive voltage for the ink ejection operation. On the other hand, when reduction in ink viscosity with time makes it easier for the ink to be ejected from the nozzles, the ejection amount can be suppressed by reducing the drive voltage for the ink ejection operation. Thus, the ejection operation can be optimized in response to a temporal change in ink, and the image quality can be maintained by preventing the ejection failure. Particularly, the processor calculates the current ink physical property information based on the elapsed time information, and controls the ejection operation according to the calculated physical property information. Thus, the ejection failure can be prevented and the image quality can be maintained by performing the optimum ink ejection operation according to the ink physical properties that change with time.

The processor may control a drive waveform formed by a drive voltage and a voltage application time for the ink ejection operation by the ink-jet head upon control of the ejection operation.

According to the above configuration, optimum ejection control can be executed according to the current ink physical properties. Thus, the image quality can be maintained by further preventing the ejection failure and deterioration in ejection recovery.

An ink-jet printer in some embodiments includes: an ink cartridge attachment unit; an ink cartridge attachable to and detachable from the ink cartridge attachment unit, and configured to store ink to be fed to the ink-jet printer and store elapsed time information on a time elapsed since manufacture of the stored ink; an ink-jet head having a nozzle and configured to eject the ink stored in the ink cartridge through the nozzle and form an image on a paper; a wiping unit configured to slide on an ink ejection surface of the ink-jet head and remove ink adhering to the ink ejection surface; a purging mechanism configured to remove, by ejection and suction, ink inside an ink ejection port of the nozzle; and a processor configured to acquire the elapsed time information held by the ink cartridge loaded in the ink cartridge attachment unit, calculate current ink physical property information based on the acquired elapsed time information, and control a maintenance condition parameter concerning an operation of the wiping unit or the purging mechanism based on the calculated physical property information.

According to the above configuration, the ink cartridge holds the elapsed time information on the time elapsed since manufacture of the stored ink, and the processor acquires the elapsed time information and controls maintenance condition parameters based on the acquired elapsed time information. Thus, when an increase in ink viscosity with time makes it difficult for the ink to be ejected from the nozzles, for example, the amount of ink to be discharged can be increased by increasing a purge pressure for purge processing. On the other hand, when reduction in ink viscosity with time makes it easier for the ink to be ejected from the nozzles, the amount of ink to be discharged can be suppressed by reducing the purge pressure for purge processing. As described above, the maintenance condition parameters after the ink replacement can be optimized in response to a temporal change in ink. Thus, the image quality can be maintained by preventing the ejection failure. Particularly, the processor calculates the current ink physical property information based on the elapsed time information, and controls the maintenance condition parameters according to the calculated physical property information. Thus, the ejection failure can be prevented and the image quality can be maintained by driving the wiping unit or the purging mechanism optimum for the ink physical properties that change with time.

The maintenance condition parameter may include at least one of pressures and time periods for ink ejection and suction by the purging mechanism, and an operation frequency, an operation speed and the number of operations by the wiping unit.

According to the above configuration, the optimum maintenance condition parameter can be appropriately selected and controlled according to the current ink physical properties based on the elapsed time information. Thus, the image quality can be maintained by further preventing the ejection failure and deterioration in ejection recovery.

An ink-jet printer in some embodiments includes: an ink cartridge attachment unit; an ink cartridge attachable to and detachable from the ink cartridge attachment unit and configured to store ink to be fed to the ink-jet printer and store elapsed time information on a time elapsed since manufacture of the stored ink; a supply tank provided in a main body of the ink-jet printer and configured to receive the ink stored in the ink cartridge and store ink including the received ink; an ink-jet head having a nozzle and configured to eject the ink stored in the supply tank through the nozzle and form an image on a paper; a pipe for supplying the ink stored in the ink cartridge to the supply tank; a circulation path for circulating the ink between the supply tank and the ink-jet head; and a processor configured to acquire the elapsed time information held by the ink cartridge loaded in the ink cartridge attachment unit, calculate current ink physical property information based on the acquired elapsed time information, and control a circulation condition parameter in the circulation path based on the calculated physical property information.

According to the above configuration, the ink cartridge holds the elapsed time information on the time elapsed since manufacture of the stored ink, and the processor acquires the elapsed time information and controls circulation condition parameters in circulation paths based on the acquired elapsed time information. Thus, when an increase in ink viscosity with time increases a nozzle pressure in the circulation path, for example, the ink can be prevented from overflowing from the nozzles by lowering the tank pressure for ink circulation. On the other hand, when reduction in ink viscosity with time lowers the nozzle pressure in the circulation path, air can be prevented from being sucked in through the nozzles by increasing the tank pressure for ink circulation. As described above, the ink circulation parameters after the ink replacement can be optimized in response to a temporal change in ink. Thus, the image quality can be maintained by preventing the ejection failure. Particularly, the processor calculates the current ink physical property information based on the elapsed time information, and controls the ink circulation parameters according to the calculated physical property information. Thus, the ejection failure can be prevented and the image quality can be maintained by performing ink circulation drive optimum for the ink physical properties that change with time.

The circulation condition parameter may include a pressure for circulating the ink by sending the ink from the supply tank to the ink-jet head and then from the ink-jet head to the supply tank, or a flow rate of the ink circulated.

According to the above configuration, the optimum ink circulation parameter can be appropriately selected and controlled according to the current ink physical properties based on the elapsed time information. Thus, the image quality can be maintained by further preventing the ejection failure and deterioration in ejection recovery.

The current ink physical property information based on the elapsed time information may include at least one of an ink viscosity, a volume elasticity, a surface tension, a density, or a specific weight of the ink.

According to the above configuration, the controllers can be controlled by appropriately selecting each item to be affected by the ink physical properties. Thus, the image quality can be maintained by further preventing the ejection failure and deterioration in ejection recovery.

An ink cartridge in some embodiments includes: a main body configured to house ink therein to be fed to an ink-jet printer, the main body being attachable to and detachable from the ink-jet printer; and a storage configured to store elapsed time information on a time elapsed since manufacture of the housed ink such that the elapsed time information is readable from the ink-jet printer.

According to the above configuration, the ink cartridge holds, in the storage, the elapsed time information on the time elapsed since manufacture of the stored ink. Thus, appropriate parameters can be set using the elapsed time information, taking into consideration the current ink physical properties based on the elapsed time information in the ink ejection operation, maintenance control, circulation control and the like in the ink-jet head. As a result, the image quality can be maintained.

### BRIEF DESCRIPTION OF DRAWINGS

FIG. 1 is an explanatory diagram showing a change in ink viscosity in an ink circulation path according to a relevant example.

FIG. 2 is a schematic configuration diagram of an ink-jet printer according to an embodiment of the present invention.

FIG. 3 is a plan view of a maintenance unit according to the embodiment.

FIG. 4 is an exploded perspective view of the maintenance unit and an ink-jet head according to the embodiment.

FIG. 5 is a cross-sectional view taken along the line V-V in FIG. 3.

FIG. 6 is a schematic configuration diagram showing a configuration of an ink circulation mechanism in a printing unit according to the embodiment.

FIG. 7 is a block diagram showing a functional module related to drive control by an arithmetic processor according to the embodiment.

FIG. 8A is an explanatory diagram showing a waveform of a drive voltage in ink ejection control.

FIG. 8B is an explanatory diagram showing a nozzle pressure in maintenance control.

FIG. 9 is a flowchart showing operations of the drive control according to the embodiment.

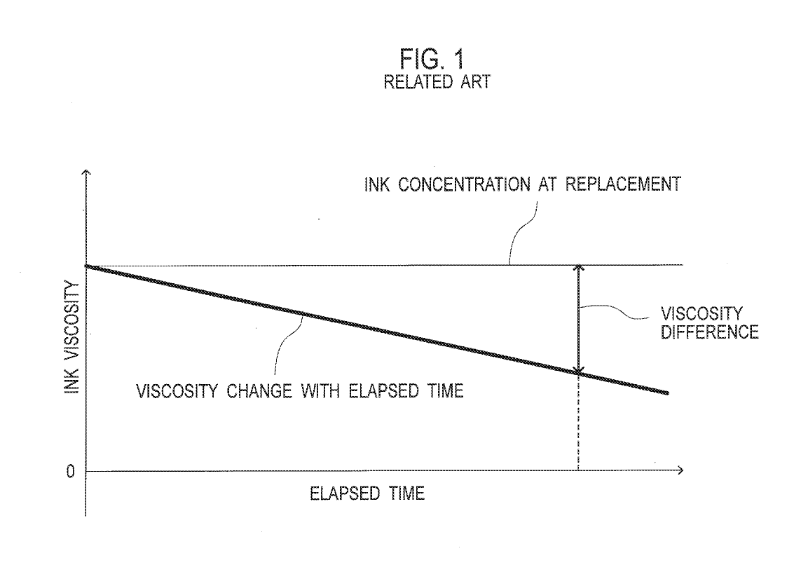

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for embodiments of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

### Overall Configuration of Ink-Jet Printer

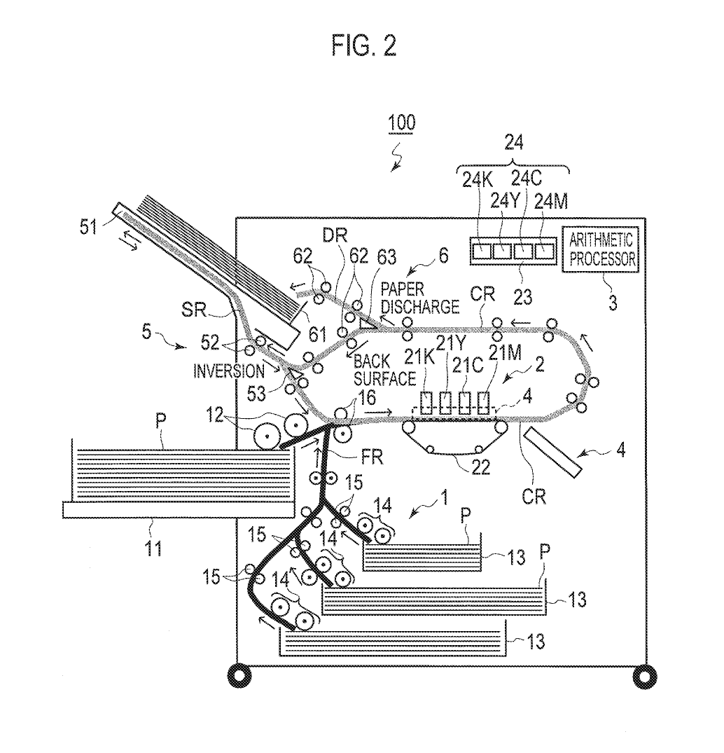

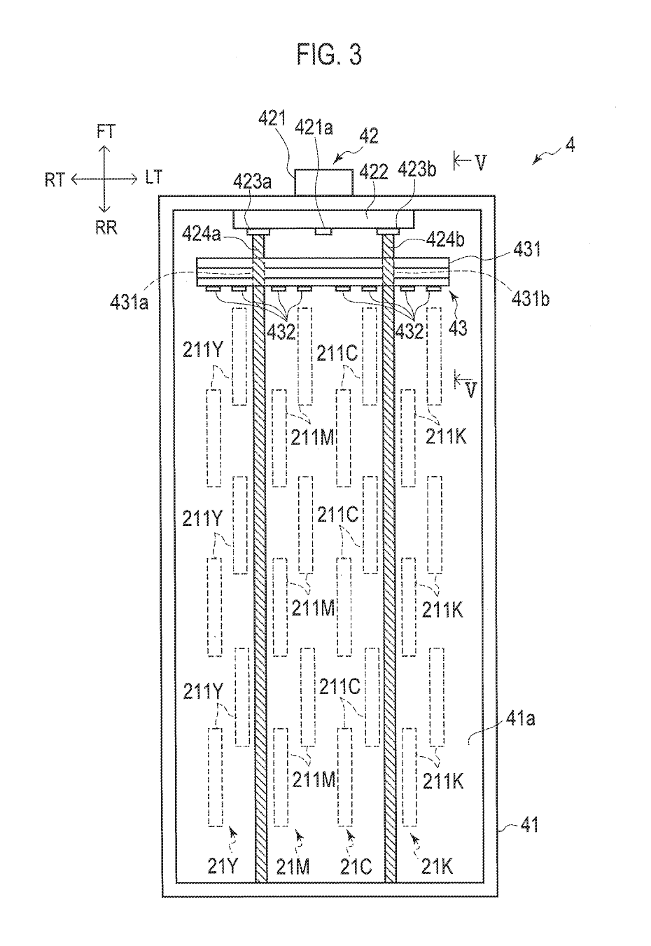

An overall configuration of an ink-jet printer 100 according to an embodiment of the present invention is described in detail. FIG. 2 is a schematic configuration diagram of the ink-jet printer 100. As shown in FIG. 2, the ink-jet printer 100 is an ink-jet apparatus configured to eject ink corresponding to image data onto paper P that is a printing medium to be conveyed on a conveyance route, thus forming an image on the paper. The ink-jet printer 100 includes a paper feeder 1, a printing unit 2, an arithmetic processor 3, a maintenance unit 4, a switch back unit 5 and a paper discharger 6. Note that, in FIGS. 3 to 6, the right direction, left direction, up direction, down direction, front direction and rear direction are denoted by RT, LT, UP, DN, FT and RR, respectively.

The paper feeder 1 includes an external paper feed tray 11, external paper feed rollers 12, internal paper feed trays 13, internal paper feed rollers 14, vertical conveyance rollers and registration rollers 16. On the external paper feed tray 11, paper P is stacked. The external paper feed tray 11 is installed to be partially exposed to the outside of a housing 10. The external paper feed rollers 12 convey the paper P onto a paper feed conveyance route FR by taking the paper P at the top one by one from the external paper feed tray 11.

On each of the internal paper feed trays 13, the paper P is stacked. The internal paper feed rollers 14 convey the paper P onto the paper feed conveyance route FR by taking the paper P at the top one by one from each of the internal paper feed trays 13. The internal paper feed rollers 14 are arranged above the internal paper feed trays 13. The vertical conveyance rollers 15 convey the paper taken from the internal paper feed trays 13 toward the registration rollers 16. The vertical conveyance rollers 15 are arranged along the paper feed conveyance route FR.

The registration rollers 16 temporarily stop the paper conveyed from the external paper feed trays 11, the internal paper feed trays 13 and the switch back unit 5, and then sends the paper to the printing unit 2 at a predetermined timing. The registration rollers 16 are arranged on a circulation conveyance route CR near the junction of the paper feed route FR and a switch back route SR. Thus, the paper P is conveyed to the registration rollers 16 from the paper feeder 1 and also from the switch back unit 5 to be described later. Therefore, behind the registration rollers 16 in the conveyance direction, there is a meeting point of a conveyance route of the fed paper P and a conveyance route along which the paper having its one side printed is circulated and conveyed. Based on the meeting point, the route on the paper feed unit side is called the paper feed conveyance route FR and the other conveyance route is called the circulation conveyance route CR. Ahead of the registration rollers 16 in the conveyance direction, the printing unit 2 is provided.

Note that, behind the registration rollers 16 in the conveyance direction, a registration sensor (not shown) is provided to detect the leading or trailing end of the paper P being conveyed. The paper feeder 1 further includes: a motor configured to rotationally drives the external paper feed rollers 12, the internal paper feed rollers 14 and the vertical conveyance rollers 15; and a drive motor (not shown) configured to rotationally drives the registration rollers 16.

The printing unit 2 includes: ink-jet heads 21 (21K, 21C, 21M and 21Y) having nozzles that eject inks; and an annular conveyer belt 22 provided to face the ink-jet heads 21 and configured to slide along the circulation conveyance route CR. The paper P fed by the registration rollers 16 is suctioned onto the conveyer belt 22 by a suction fan (not shown) provided inside the annular conveyer belt 22 to correspond to the back of the paper conveyance route surface, and configured to suction the paper P onto the upper surface of the conveyer belt 22 for conveyance. The paper P is printed using the inks ejected from the ink-jet heads 21 while being conveyed at a predetermined conveyance speed.

The ink-jet heads 21K, 21C, 21M and 21Y eject inks onto the conveyed paper P. The ink-jet heads 21K, 21C, 21M and 21Y eject black (K), cyan (C), magenta (M) and yellow (Y) inks, respectively. Each of the ink-jet heads 21K, 21C, 21M and 21Y have a number of nozzles provided on its lower surface to eject the ink. Note that the ink-jet heads 21K, 21C, 21M and 21Y have the same configuration except that the colors of the inks to be ejected are different. Therefore, the alphabetical letters (K, C, M and Y) indicating the colors in reference numerals of the ink-jet heads 21K, 21C, 21M and 21Y may be omitted for collective notation.

The conveyer belt 22 can be moved downward from the position shown in FIG. 2 by an unillustrated elevator motor. When the conveyer belt 22 is moved downward, a space is formed between the ink-jet heads 21 and the conveyer belt 22, and the maintenance unit 4 can be arranged in the space.

Furthermore, the printing unit 2 is provided with a cartridge attachment mechanism (ink cartridge attachment unit) 23 for attaching ink cartridges 24 at the front of the printer. In the cartridge attachment mechanism 23, the ink cartridges 24 (24K, 24Y, 24C and 24M) of the respective colors are loaded. The ink cartridges 24 are elongated housings which are provided to be attachable to and detachable from the ink-jet printer 100 (ink cartridge attachment unit 23), and are attached/detached in a horizontal direction to/from the ink-jet printer 100. Each of the ink cartridges 24 mainly includes a liquid container (main body) having ink sealed therein and an outer package (main body) into which the liquid container is inserted. Each of the ink cartridges 24 has an engagement surface fitted on its end face on the ink-jet printer 100 side. The engagement surface is engaged with the cartridge attachment mechanism 23 on the ink-jet printer 100 side. The engagement surface is made of a hard material such as resin and metal, and is configured to be fitted to the cartridge attachment mechanism 23 in the ink-jet printer 100.

Moreover, the engagement surface has a storage (RFID) tag 24a (storage) attached thereto, which performs contactless communication with a contactless communication interface 301 provided on the ink-jet printer 100 side. The storage tag 24a uses radio waves received from the contactless communication interface 301 to generate internal power, and uses the power to read and write data from and into a memory. The storage tag 24a also has a communication function to transmit and receive data through the contactless communication interface 301. Moreover, the memory of the storage tag 24a stores ink information. The ink information includes information on physical properties of the ink (hereinafter referred to as ink physical property information), elapsed time information on the time elapsed since the manufacture of the stored ink, and the like, besides the color and type, water-based or oil-based, of the ink in the cartridge, and the number of times of attachment and detachment.

Here, the elapsed time information on the time elapsed is information that enables calculation of time elapsed since the manufacture. The elapsed time information includes, for example, date information on the year, month and day of manufacture, and age information in which the elapsed time is classified into certain ranges (e.g., 3 months, 6 months and 1 year since manufacture, each range referred to as “new”, “normal”, “old” or the like). The ink physical property information includes physical properties such as viscosity, volume elasticity, density or specific weight (weight per unit volume), surface tension and concentration. Each of the pieces of physical property information includes an initial value measured during manufacture or factory shipment and temporal change information (such as a coefficient for calculating each piece of ink physical property information that changes with the lapse of time) indicating a change in physical property with time. Note that, in this embodiment, the storage tag 24a stores the elapsed time information on the time elapsed since the manufacture. However, the storage tag 24a may store elapsed time information on time elapsed since first opening or loading, for example.

In this embodiment, when loading of the ink cartridges 24 in the cartridge attachment mechanism 23 is detected, the storage tag 24a starts communicating with the contactless communication interface 301 and transmits data stored in the storage tag. Note that the information in the storage tag 24a is measured during manufacture or shipment.

Note that, when the ink cartridges are attached to the ink-jet printer 100, an attachment detection sensor provided on the ink-jet printer 100 side detects the attachment. To be more specific, the attachment detection sensor is a light-receiving sensor configured to detect the presence of an object shielding light received. When the received light is shielded by a convex part approached by the light-receiving sensor during attachment, the attachment is detected.

The paper P printed by the printing unit 2 is conveyed on the circulation conveyance route CR inside the housing by the conveyance rollers and the like arranged on the circulation conveyance route CR. On the circulation conveyance route CR, a switching mechanism 63 is provided to switch whether the paper P conveyed on the circulation conveyance route CR is guided to the paper discharger 6 or recirculated on the circulation conveyance route CR.

The switching mechanism 63 that is one of the conveyance units performs switching to guide the paper P to one of the paper discharger 6 and the switch back unit 5 to be described later. The paper discharger 6 includes: a paper receiving tray 61 having a tray shape that protrudes from the housing of the ink-jet printer 100; and a pair of paper discharge rollers 62 for guiding the paper P to the paper receiving tray 61. Then, the paper P guided to the paper discharger 6 by the switching mechanism 63 is conveyed to the paper receiving tray 61 by the paper discharge rollers 62 and loaded on the paper receiving tray 61 with its printed side down.

The switch back unit 5 that is one of the conveyance units includes: an inversion table 51 for turning the paper P inside out; and inversion rollers 52 for conveying the paper P from the circulation conveyance route CR onto the inversion table 51 or for conveying the paper P from the inversion table 51 onto the circulation conveyance route CR.

The paper P guided to the switch back unit 5 by the switching mechanism 63 is conveyed to the inversion table 51 from the circulation conveyance route CR along the switch back route SR by the inversion rollers 52, and then conveyed from the inversion table 51 to the circulation conveyance route CR after a lapse of a predetermined period of time. Thus, the front and back of the paper are turned inside out with respect to the circulation conveyance route CR. Then, the paper P having its front and back turned inside out is conveyed on the circulation conveyance route CR toward the printing unit 2 by a switching mechanism 53 and conveyance rollers provided on the circulation conveyance route CR. As described above, during double-sided printing, the switch back unit 5 uses the switching mechanism 63 to perform an operation of allowing the paper P finished with front-side printing to break into the paper P to be subjected to front-side printing by returning the paper P to the circulation conveyance route CR after turning its front and back inside out for back-side printing.

The ink-jet printer 100 also includes an arithmetic processor 3 configured to control the entire ink-jet printer 100. The arithmetic processor 3 is an arithmetic module including a processor such as a CPU and a digital signal processor (DSP), a memory, other hardware such as an electronic circuit, software such as a program having such functions, or a combination thereof. The arithmetic processor 3 virtually constructs various functional modules by reading and executing appropriate programs, and uses the constructed functional modules to perform processing of image data, control operations of the units and perform various kinds of processing for user operations. To be more specific, the arithmetic processor 3 executes print processing based on a print job by controlling the paper feeder 1, the printing unit 2, the paper discharger 6, the switch back unit 5 and the maintenance unit 4. Also, the arithmetic processor 3 adjusts drive waveform control, ink circulation control and maintenance control for the ink-jet heads 21 during replacement of the ink cartridges 24.

The maintenance unit 4 cleans ink ejection surfaces 211a of the ink-jet heads 21. During printing, the maintenance unit 4 is arranged at a standby position indicated by the solid line in FIG. 2. On the other hand, during cleaning, the maintenance unit 4 is arranged by the elevator motor at a cleaning position indicated by the broken line in FIG. 2. The cleaning position is between the ink-jet heads 21 and the conveyer belt 22.

### Maintenance Unit 4

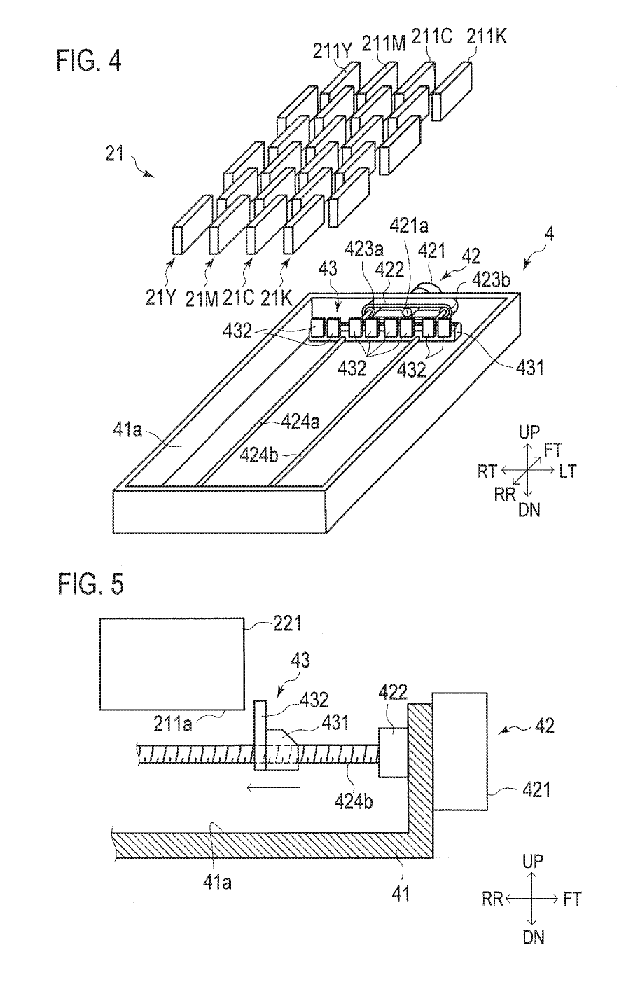

Next, a configuration of the maintenance unit 4 is described. FIG. 3 is a plan view of the maintenance unit according to this embodiment. FIG. 4 is an exploded perspective view of the maintenance unit 4 and the ink-jet heads 21. FIG. 5 is a cross-sectional view taken along the line V-V in FIG. 3.

First, a configuration of the ink-jet heads 21 is described. In this embodiment, the ink-jet head 21C includes six unit heads 211C arranged in a 3×2 zigzag matrix pattern. Likewise, the ink-jet heads 21K, 21M and 21Y also include six unit heads 211K, 211M and 211Y, respectively. Note that, in such a case as where there is no need to make a distinction among the colors, the alphabetical letters (C, K, M and Y) indicating the colors in reference numerals may be omitted and the ink-jet heads may be denoted by reference numeral “21” and the unit heads may be denoted by reference numeral “211”. An ink-repellent film is formed on each of the ink ejection surfaces (nozzle surfaces) 211a of the unit heads 211 in the ink-jet heads 21. The ink-repellent film is made of a material having ink repellency, e.g., amorphous fluorine resin.

Meanwhile, as shown in FIGS. 3 to 5, the maintenance unit 4 includes an ink-receiving member 41, a drive unit 42 and a wiping unit 43. Note that FIGS. 3 to 5 show a state where the maintenance unit 4 is arranged at a maintenance position. The wiping unit 43 can slidably come into contact with the ink ejection surface 211a of the unit head 211.

The ink-receiving member 41 receives ink and the like removed by cleaning. The ink-receiving member 41 holds the members in the maintenance unit 4. The ink-receiving member 41 is formed in a rectangular parallelepiped shape. In the center of the ink-receiving member 41, a concave part 41a is formed to receive the ink and the like. In a plan view, the concave part 41a is formed to be larger than the region where the ink-jet heads 21 are arranged. The upper side of the ink-receiving member 41 has an opening. In this embodiment, after the ink-receiving member 41 is moved to the position below the ink-jet heads 21, a purging mechanism is driven by controlling the arithmetic processor 3. Thus, purging processing is performed to remove the ink inside the ejection ports by ejection and suction. Note that the purging mechanism includes an ink circulation mechanism 2a to be described later and the maintenance unit 4.

Thereafter, wiping processing is performed to wipe the ink ejection surfaces 211a by making the wiping unit 43 come into contact with the ink ejection ports of the ink-jet heads 21. Here, the purging processing is the processing of ejecting and suctioning the ink inside the ejection ports by changing a pressure in the ink circulation path or applying a voltage to the ink-jet heads 21. Meanwhile, the wiping processing is the processing of removing the ink and the like by making the wiping unit 43 slidably come into contact with the ink ejection surfaces 211a of the unit heads 211.

The drive unit 42 moves the wiping unit 43 in a longitudinal direction during maintenance. The drive unit 42 includes a wiper drive motor 421, a drive belt 422, a pair of drive pulleys 423a and 423b, and a pair of screw gears 424a and 424b.

The wiper drive motor 421 generates rotational drive force. The wiper drive motor 421 is arranged on the outside of a front surface of the ink-receiving member 41. The wiper drive motor 421 includes an output gear 421a. The output gear 421a transmits the rotational drive force of the wiper drive motor 421 to the drive belt 422. The output gear 421a is arranged in the center of the drive belt 422. The drive belt 422 transmits the rotational drive force transmitted from the wiper drive motor 421 to the drive pulleys 423a and 423b. The drive belt 422 is wound around the drive pulleys 423a and 423b.

The pair of drive pulleys 423a and 423b transmit the rotational drive force transmitted from the drive belt 422 to the screw gears 424a and 424b. The drive pulleys 423a and 423b are arranged at the same height with a predetermined space therebetween in a horizontal direction. The drive pulleys 423a and 423b are rotatably supported on the front part of the ink-receiving member 41.

The screw gears 424a and 424b use the rotational drive force transmitted from the wiper drive motor 421 to move the wiping unit 43 in the longitudinal direction. The screw gears 424a and 424b are provided to extend along approximately the entire length of the concave part 41a in the longitudinal direction. The screw gears 424a and 424b have their front ends fixed to rear ends of the drive pulleys 423a and 423b, respectively. The screw gears 424a and 424b have their rear ends rotatably supported on the right wall of the ink-receiving member 41. Thus, the screw gears 424a and 424b are rotated together with the drive pulleys 423a and 423b, respectively.

The wiping unit 43 is a drive mechanism for removing the ink adhering around the ejection ports by slidably coming into contact with the vicinity of the ejection ports of the ink-jet heads 21 during the maintenance. The wiping unit 43 includes an attachment table 431 and eight wipers 432.

The attachment table 431 is formed of a member having the shape of a prism elongated in the horizontal direction, and the wipers 432 are attached to the attachment table 431. The attachment table 431 has a pair of screw holes formed therein. The screw gears 424a and 424b are inserted and screwed in the respective screw holes. Thus, when the screw gears 424a and 424b are rotated, the attachment table 431 is moved in the longitudinal direction.

The wipers 432 remove the ink and the like by sliding on the ink ejection surfaces 211a of the unit heads 211 in the ink-jet heads 21. The wipers 432 are made of a material such as elastically deformable rubber. It is preferable that the material of the wipers 432 is elastic-enough not to damage the ink ejection surfaces 211a. The wipers 432 are formed to have a rectangular thin plate shape. The wipers 432 have their lower ends fixed to the rear surface of the attachment table 431 with unillustrated fixtures. As shown in FIG. 3, each of the eight wipers 432 is arranged on an extension line of the row of unit heads 211 arranged in the longitudinal direction in the plan view. As shown in FIG. 3, upper ends of the wipers 432 are formed to be higher than the upper surface of the attachment table 431. The upper ends of the wipers 432 are arranged to be higher than the ink ejection surfaces 211a of the unit heads 211 at the maintenance position. Thus, when moved in the longitudinal direction to come into contact with the unit heads 211, the wipers 432 are elastically deformed and slide on the ink ejection surfaces 211a. Note that, although not shown, the maintenance unit 4 includes a motor device configured to move the maintenance unit 4 between the standby position indicated by the solid line and the cleaning position indicated by the broken line in FIG. 2.

### Configuration of Ink Circulation Mechanism

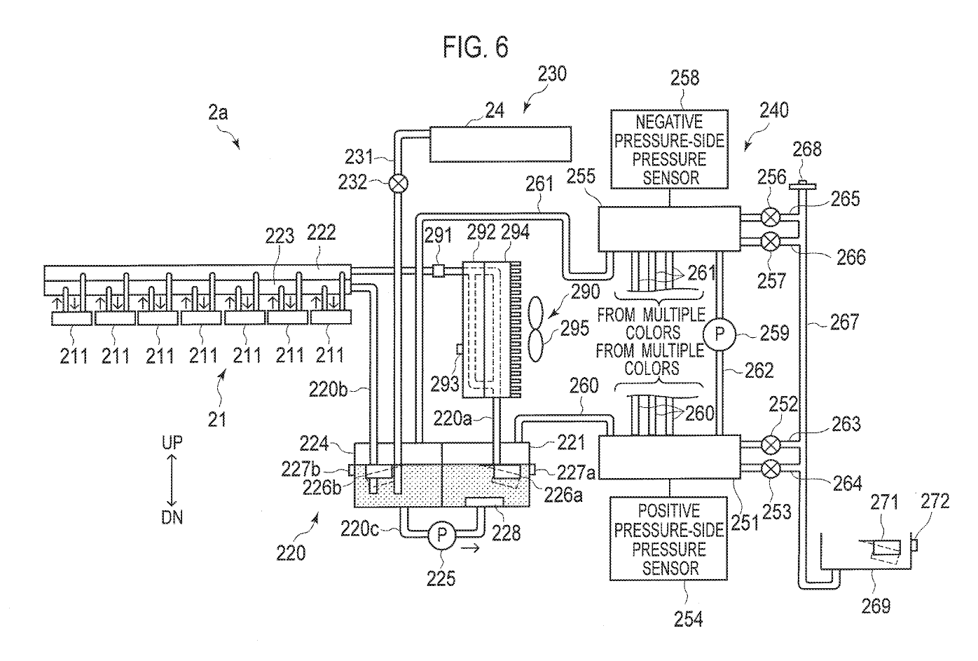

Next, a configuration of the ink circulation mechanism 2a in the printing unit 2 is described. FIG. 6 is a schematic configuration diagram showing a configuration of the ink circulation mechanism 2a in the printing unit 2 according to this embodiment. Note that, in the example of FIG. 6, description is given of one ink color. However, in a color printer configured to perform color printing with multiple colors of ink, the configuration of the ink circulation mechanism may be provided to correspond to each ink color. As shown in FIG. 6, the ink circulation mechanism 2a in the printing unit 2 includes the ink-jet head 21, an ink circulator 220, an ink supplier 230 and a pressure regulator 240.

The ink-jet head 21 ejects ink supplied from the ink circulator 220. The ink-jet head 21 includes the unit heads 211. The unit heads 211 are of a piezoelectric type. Each of the unit heads 211 includes an ink chamber configured to store the ink and a number of nozzles configured to eject the ink (both not shown). A piezoelectric element (not shown) is arranged in the ink chamber. The ink is ejected from the nozzles by driving the piezoelectric element.

In order for the ink-jet head to normally eject the ink, a pressure (nozzle pressure) applied to the nozzles of the ink-jet head 21 needs to be maintained at an appropriate negative pressure. In the ink-jet printer 100 of an ink circulation type, the nozzle pressure is controlled by controlling pressures of a positive-pressure tank and a negative-pressure tank.

The ink circulator 220 supplies ink to the ink-jet head 21 while circulating the ink. The ink circulator 220 includes a positive-pressure tank 221, an ink distributor 222, a collector 223, a negative-pressure tank 224, an ink pump 225, an ink temperature regulator 290, an ink temperature sensor 291 and circulation paths 220a to 220c.

The positive-pressure tank 221 is a supply tank provided in the main body of the ink-jet printer 100 and configured to store ink to be supplied to the ink-jet head 21. The ink in the positive-pressure tank 221 is supplied to the ink-jet head 21 through the circulation path 220a and the ink distributor 222. In the positive-pressure tank 221, an air layer is formed on the surface of the ink. The positive-pressure tank 221 is communicated with a positive-pressure common air chamber 251 to be described later through a pipe 260 to be described later. The positive-pressure tank 221 is arranged at a position lower than (below) the ink-jet head 21.

The positive-pressure tank 221 has a capacity capable of receiving the ink, in the ink distributor 222 and the circulation path 220a, flowing down to the positive-pressure tank 221 when the meniscus of the nozzles in the ink-jet head 21 is damaged by vibration. However, when the positive-pressure tank 221 is too large, the printer is increased in size. Therefore, the positive-pressure tank 221 has a capacity that is filled up when all of the ink in the ink distributor 222 and the circulation path 220a flows down to the positive-pressure tank 221.

The positive-pressure tank 221 is provided with a float member 226a, a positive-pressure tank ink level sensor 227a and an ink filter 228. The float member 226a has its one end supported by a support shaft (not shown) inside the positive-pressure tank 221 to pivot on the support shaft as the level of the ink in the positive-pressure tank 221 changes until the ink level reaches a reference level. A magnet (not shown) is provided on the other end of the float member 226a.

The positive-pressure tank ink level sensor 227a is configured to detect whether or not the level of the ink in the positive-pressure tank 221 has reached the reference level. The reference level is at a position lower than the upper end of the positive-pressure tank 221 by a predetermined distance. The ink filter 228 removes dust and the like in the ink.

The ink distributor 222 distributes the ink supplied from the positive-pressure tank 221 through the circulation path 220a to the unit heads 211 in the ink-jet head 21. The collector 223 collects the ink not consumed by the ink-jet head 21 from the unit heads 211. The ink collected by the collector 223 flows to the negative-pressure tank 224 through the circulation path 220b.

The negative-pressure tank 224 is a tank provided in the main body of the ink-jet printer 100 and configured to store the ink not consumed by the ink-jet head 21 after receiving the ink from the collector 223. The negative-pressure tank 224 also functions as a supply tank configured to store ink to be supplied to the ink-jet head 21 through the positive-pressure tank 221. The negative-pressure tank 224 also stores ink to be supplied from the ink cartridges 24 in the ink supplier 230 to be described later. In the negative-pressure tank 224, an air layer is formed on the surface of the ink. The negative-pressure tank 224 is communicated with a negative-pressure common air chamber 255 to be described later through a pipe 261 to be described later. The negative-pressure tank 224 is arranged at the same height as the positive-pressure tank 221.

The negative-pressure tank 224 has a capacity capable of receiving the ink, in the ink-jet head 21, the collector 223 and the circulation path 220b, flowing down to the negative-pressure tank 224 when the meniscus of the nozzles in the ink-jet head 21 is damaged by vibration. However, when the negative-pressure tank 224 is too large, the printer is increased in size. Therefore, the negative-pressure tank 224 has a capacity that is filled up when all of the ink in the ink-jet head 21, the collector 223 and the circulation path 220b flows down to the negative-pressure tank 224.

The negative-pressure tank 224 is provided with a float member 226b and a negative-pressure tank ink level sensor 227b. The float member 226b and the negative-pressure tank ink level sensor 227b are the same as the float member 226a and the positive-pressure tank ink level sensor 227a in the positive-pressure tank 221, respectively. The reference level is at a position lower than the upper end of the negative-pressure tank 224 by a predetermined distance. The ink pump 225 sends the ink from the negative-pressure tank 224 to the positive-pressure tank 221. The ink pump 225 is provided in the circulation path 220c.

The ink temperature regulator 290 regulates the temperature of the ink in the ink circulator 220. The ink temperature regulator 290 is provided in the circulation path 220a. The ink temperature regulator 290 includes a heater 292, a heater temperature sensor 293, a heat sink 294 and a cooling fan 295.

The heater 292 heats the ink in the circulation path 220a. The heater temperature sensor 293 detects the temperature of the heater 292. The heat sink 294 cools the ink in the circulation path 220a. The cooling fan 295 sends cooling air to the heat sink 294. The ink temperature sensor 291 detects the temperature of the ink in the ink circulator 220. The ink temperature sensor 291 is provided in the circulation path 220a.

The circulation paths 220a to 220c are pipes for circulating the ink between the supply tank and the ink-jet head 21. The circulation path 220a connects the positive-pressure tank 221 to the ink distributor 222. The circulation path 220a is partially branched into a portion passing through the heater 292 and a portion passing through the heat sink 294. In the circulation path 220a, the ink flows toward the ink distributor 222 from the positive-pressure tank 221. The circulation path 220b connects the collector 223 to the negative-pressure tank 224. In the circulation path 220b, the ink flows toward the negative-pressure tank 224 from the collector 223. The circulation path 220c connects the negative-pressure tank 224 to the positive-pressure tank 221. In the circulation path 220c, the ink flows toward the positive-pressure tank 221 from the negative-pressure tank 224.

The ink supplier 230 supplies ink to the ink circulator 220. The ink supplier 230 includes the ink cartridge 24, a pipe 231 and an ink supply valve 232. The ink cartridge 24 houses ink to be used for printing by the printing unit 2. The ink cartridge 24 stores new ink to be filled in the positive-pressure tank 221 and the negative-pressure tank 224 or in the circulation paths 220a to 220c. The ink in the ink cartridge 24 is supplied to the negative-pressure tank 224 through the pipe 231. The pipe 231 connects the ink cartridge 24 to the negative-pressure tank 224. In the pipe 231, the ink flows toward the negative-pressure tank 224 from the ink cartridge 24. The ink supply valve 232 opens and closes an ink flow path inside the pipe 231. The ink supply valve 232 is opened to supply the ink from the ink cartridge 24 to the negative-pressure tank 224.

The pressure regulator 240 regulates the pressures in the positive-pressure tank 221 and the negative-pressure tank 224 in each printing unit 2. The pressure regulator 240 includes the positive-pressure common air chamber 251, a positive pressure-side pressure regulating valve 252, a positive pressure-side atmospheric air open valve 253, a positive pressure-side pressure sensor 254, the negative-pressure common air chamber 255, a negative pressure-side pressure regulating valve 256, a negative pressure-side atmospheric air open valve 257, a negative pressure-side pressure sensor 258, an air pump 259, four pipes 260, four pipes 261, pipes 262 to 267, an air filter 268 and an overflow pan 269.

The positive-pressure common air chamber 251 is an air chamber for equalizing the pressures in the positive-pressure tanks 221 in the printing units 2. The positive-pressure common air chamber 251 is communicated with air layers in the positive-pressure tanks 221 corresponding to the respective four printing units 2 through the four pipes 260. Thus, the positive-pressure tanks 221 in the respective printing units 2 are communicated with each other through the positive-pressure common air chamber 251 and the pipes 260.

The positive pressure-side pressure regulating valve 252 opens and closes an air flow path inside the pipe 263 to regulate the pressures in the positive-pressure tanks 221 in the respective printing units 2 through the positive-pressure common air chamber 251. The positive pressure-side pressure regulating valve 252 is provided on the pipe 263. The positive pressure-side atmospheric air open valve 253 opens and closes an air flow path inside the pipe 264 to switch the positive-pressure tanks 221 in the respective printing units 2 between a sealed state (a state of being cut off from the atmosphere) and an atmospheric air open state (a state of being communicated with the atmosphere) through the positive-pressure common air chamber 251. The positive pressure-side atmospheric air open valve 253 is provided on the pipe 264.

The positive pressure-side pressure sensor 254 detects the pressure (positive pressure-side pressure) in the positive-pressure common air chamber 251. Here, the pressure in the positive-pressure common air chamber 251 is equal to the pressures in the positive-pressure tanks 221 in the respective printing units 2. This is because the positive-pressure common air chamber 251 is communicated with the air layers in the positive-pressure tanks 221 in the respective printing units 2.

The negative-pressure common air chamber 255 is an air chamber configured to equalize the pressures in the negative-pressure tanks 224 in the respective printing units 2. The negative-pressure common air chamber 255 is communicated with air layers in the negative-pressure tanks 224 corresponding to the four printing units 2 through the four pipes 261. Thus, the negative-pressure tanks 224 in the respective printing units 2 are communicated with each other through the negative-pressure common air chamber 255 and the pipes 261.

The negative pressure-side pressure regulating valve 256 opens and closes an air flow path inside the pipe 265 to regulate the pressures in the negative-pressure tanks 224 in the respective printing units 2 through the negative-pressure common air chamber 255. The negative pressure-side pressure regulating valve 256 is provided on the pipe 265. The negative pressure-side atmospheric air open valve 257 opens and closes an air flow path inside the pipe 266 to switch the negative-pressure tanks 224 in the respective printing units 2 between a sealed state and an atmospheric air open state through the negative-pressure common air chamber 255. The negative pressure-side atmospheric air open valve 257 is provided on the pipe 266.

The negative pressure-side pressure sensor 258 detects the pressure (negative pressure-side pressure) in the negative-pressure common air chamber 255. Here, the pressure in the negative-pressure common air chamber 255 is equal to the pressures in the negative-pressure tanks 224 in the respective printing units 2. This is because the negative-pressure common air chamber 255 is communicated with the air layers in the negative-pressure tanks 224 in the respective printing units 2.

The air pump 259 sends air from the negative-pressure tanks 224 in the respective printing units 2 to the positive-pressure tanks 221 through the positive-pressure common air chamber 251 and the negative-pressure common air chamber 255. The air pump 259 is provided in the pipe 262.

The four pipes 260 connect the positive-pressure common air chamber 251 to the positive-pressure tanks 221 in the four printing units 2. Each of the pipes 260 has one end connected to the positive-pressure common air chamber 251 and the other end connected to the air layer in the positive-pressure tank 221. The four pipes 261 connect the negative-pressure common air chamber 255 to the negative-pressure tanks 224 in the four printing units 2. Each of the pipes 261 has one end connected to the negative-pressure common air chamber 255 and the other end connected to the air layer in the negative-pressure tank 224.

The pipe 262 forms a flow path of air to be sent to the positive-pressure common air chamber 251 from the negative-pressure common air chamber 255 by the air pump 259. The pipe 262 has one end connected to the negative-pressure common air chamber 255 and the other end connected to the positive-pressure common air chamber 251. Each of the pipes 263 and 264 has one end connected to the positive-pressure common air chamber 251 and the other end connected to the pipe 267. Each of the pipes 265 and 266 has one end connected to the negative-pressure common air chamber 255 and the other end connected to the pipe 267. The pipe 267 has one end (upper end) communicated with the atmosphere through the air filter 268 and the other end connected to the overflow pan 269.

The air filter 268 is provided at the upper end of the pipe 267 and configured to prevent dust and the like contained in the external air from entering. The overflow pan 269 receives ink overflowing from the positive-pressure tank 221 and the negative-pressure tank 224 due to abnormality in the ink supply valve 232, for example, and also overflowing from the positive-pressure common air chamber 251 and the negative-pressure common air chamber 255. The overflow pan 269 is provided with a float member 271 and an overflow ink level sensor 272. The float member 271 and the overflow ink level sensor 272 are the same as the float member 226a and the positive-pressure tank ink level sensor 227a in the positive-pressure tank 221, respectively. The overflow pan 269 is connected to a waste tank (not shown) and configured to discharge the ink to the waste tank when the overflow ink level sensor 272 is turned on.

Note that the ink circulation mechanism 2a described above circulates the ink in the ink circulator 220 not only during print execution but also during maintenance, and also functions as a part of the purging mechanism for maintenance processing.

### Functional Configuration of Arithmetic Processor 3

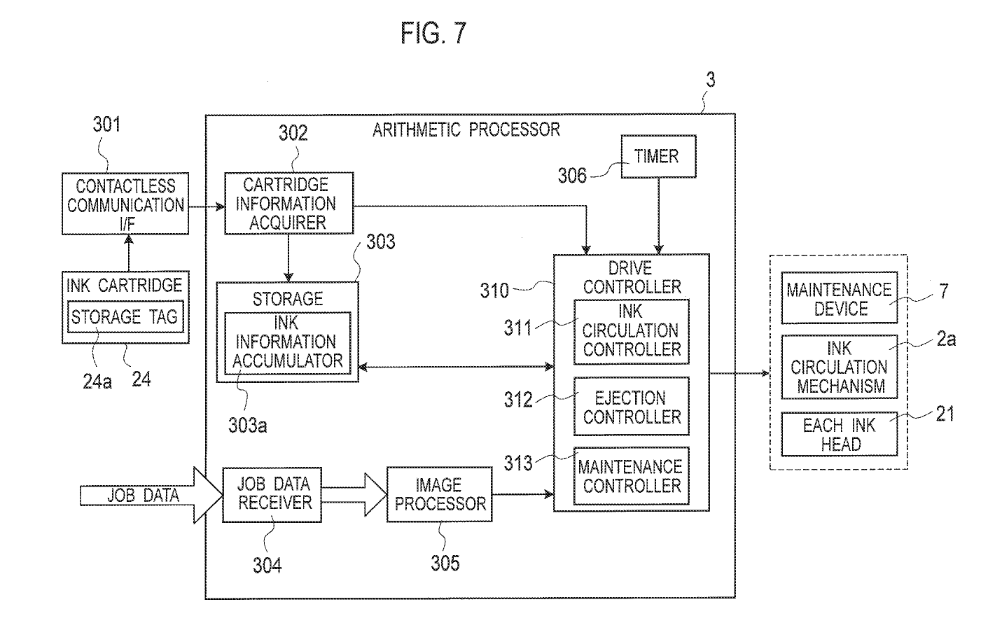

The ink-jet printer 100 having the above configuration has a function to adjust each drive control during ink replacement. This function is executed by the arithmetic processor 3 controlling the operations of the printing unit 2, the maintenance unit 4 and the like. FIG. 7 is a block diagram showing a functional module for drive control by the arithmetic processor 3 according to this embodiment. Note that the “module” used in the description includes hardware such as an apparatus and a device, software having such functions or a combination thereof, and represents a function unit to achieve a predetermined operation.

As shown in FIG. 7, the arithmetic processor 3 mainly includes the contactless communication interface 301, a cartridge information acquirer 302, a storage 303, a job data receiver 304, an image processor 305 and a drive controller 310.

The contactless communication interface 301 is a module configured to transmit and receive radio signals to and from the storage tag 24a when the ink cartridge 24 is loaded in the ink-jet printer 100, and to acquire information on ink stored and held in the storage tag 24a.

The cartridge information acquirer 302 is a module configured to receive the information on the ink stored and held in the storage tag 24a through the contactless communication interface 301 and to acquire the information as data. In this embodiment, the cartridge information acquirer 302 instructs the contactless communication interface 301 to start contactless communication when detecting, through the attachment detection sensor, whether or not the ink cartridge 24 is attached to the cartridge attachment mechanism 23.

A timer 306 is a module configured to acquire the current date and time information. As such date and time information to be acquired, date and time information may be acquired from a system clock in the ink-jet printer 100, or date and time information may be acquired from a time server arranged on a communication network. The acquired date and time information is transmitted to the drive controller 310. Note that the date and time information may include time information.

The storage 303 includes a ROM for pre-storing various programs and parameters, a RAM for temporarily storing programs and data as a workspace, a hard disk used to store various programs and parameters. In this embodiment, particularly, the storage 303 includes an ink information accumulator 303a configured to accumulate ink information recorded in the storage tag 24a. This ink information includes elapsed time information on the time elapsed since manufacture of the ink, ink physical property information, and the like.

The job data receiver 304 is a communication interface configured to receive job data that is a series of print processing units, and is a module configured to hand over data included in the received job data to the image processor 305. The communication here also includes short-distance communication such as infrared communication, besides intranet (network within a company) using 10BASE-T, 100BASE-TX or the like and a LAN such as a home network, for example. The image processor 305 is an arithmetic processor configured to perform digital signal processing dedicated to image processing. Also, the image processor 305 is a module configured to perform image data conversion and the like required for printing, and executes digital signal processing dedicated to image processing, such as conversion of an RGB print image into a CMYK print image.

The drive controller 310 is a module configured to control the entire ink-jet printer 100 by drive-controlling units such as the printing unit 2, the paper feeder 1, the paper discharger 6 and the switch back unit 5. The drive controller 310 executes, for example, drive of the ink-jet heads of the colors, an operation of the drive unit for the conveyance route, maintenance processing and the like. Particularly, in this embodiment, the drive controller 310 includes an ejection controller 312, an ink circulation controller 311 and a maintenance controller 313.

The ejection controller 312 is a module configured to control the ink-jet heads 21 in the printing unit 2 based on image data and print conditions included in a print job. The ejection controller 312 calculates an ink ejection amount for each dot based on the image data after image processing, and outputs the calculated ink ejection amount to the driver of the ink-jet heads 21. The driver outputs a drive signal having a predetermined voltage value to a piezoelectric element group, based on the acquired control data. The piezoelectric element group is deformed in response to the drive signal, thereby ejecting ink from the nozzles in each of the ink-jet heads 21.

The ink circulation controller 311 is a module configured to control the units in the ink circulation mechanism 2a. To be more specific, the ink circulation controller 311 regulates the pressures in the positive-pressure tank 221 and the negative-pressure tank 224 by drive-controlling the negative pressure-side pressure regulating valve 256 and the positive pressure-side pressure regulating valve 252. Also, the ink circulation controller 311 supplies ink to the ink-jet heads 21 while circulating the ink in the ink circulation mechanism 2a by drive-controlling the ink pump 225. Moreover, the ink circulation controller 311 adjusts the ink amount by controlling the opening and closing of the ink supply valve 232 and supplying the ink to the negative-pressure tank 224 from the ink cartridge 24.

The maintenance controller 313 is a module configured to perform purging processing and wiping processing for the purpose of preventing or resolving nozzle clogging by removing unwanted material such as dried ink on the surface of the ink-jet head. The maintenance controller 313 forcibly discharges ink from the ink-jet head 21 by driving the positive pressure-side pressure regulating valve 252 to increase the pressure in the ink circulator 220 or applying a voltage to the ink-jet head 21, as the purging processing. Note that the pressure in the ink circulator 220 is increased by driving the positive pressure-side pressure regulating valve 252 and the like. Moreover, the maintenance controller 313 removes ink and the like by driving the drive unit 42 to slide on the ink ejection surface 211a of the unit head 211, as the wiping processing.

As for the ink, here, ink physical properties, such as ink viscosity, change with the passage of time. Therefore, in this embodiment, the ejection controller 312, the ink circulation controller 311 and the maintenance controller 313 in the drive controller 310 have a function to adjust the control of the units based on the ink physical property information held by the ink cartridge, the elapsed time information on the time elapsed, and the like. Here, the ink physical property information includes viscosity, volume elasticity, surface tension, density, specific weight, and the like of ink of each color. Each of the controllers selects at least one of the pieces of physical property information of ink of each color.

For example, the volume elasticity κ, the density ρ, and the speed of sound c have the relationship expressed by the following equation.

c=(κ/ρ)_{1/2}

According to the above equation, for example, when the density ρ is large, the speed of sound is decreased and thus the wavelength is increased. On the other hand, when the density ρ is small, the speed of sound is increased and thus the wavelength is reduced. Meanwhile, when the volume elasticity κ is large, the speed of sound is increased and thus the wavelength is reduced. On the other hand, when the volume elasticity κ is small, the speed of sound is decreased and thus the wavelength is increased. Such ink physical property information such as the volume elasticity and density differs for each ink type, each color and each manufacturing lot, and is thus recorded and held in the ink cartridge after measurement thereof during manufacture or shipment.

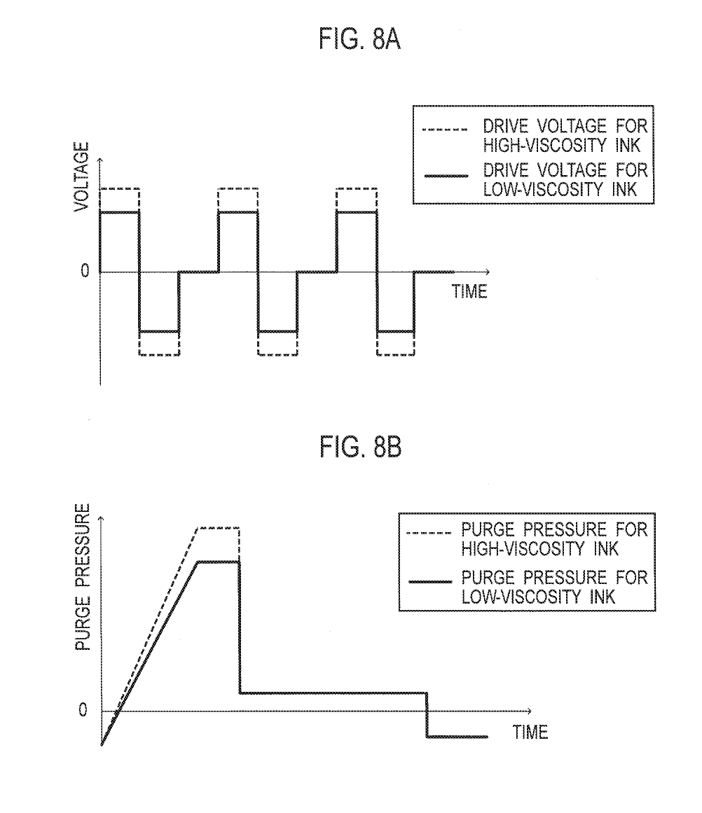

Hereinafter, detailed description is given of adjustment of the drive control in the controllers in the drive controller 310. FIG. 8A is an explanatory diagram showing a waveform of a drive voltage in ink ejection control. FIG. 8B is an explanatory diagram showing a nozzle pressure in maintenance control according to this embodiment. Note that the following description is given of the case, as an example, where ink viscosity is used as the ink physical property information and adjustment is made based on the viscosity. Also, here, description is given of the case where the ink viscosity decreases as time proceeds.

### (1) Control by Ejection Controller

First, control by the ejection controller is described in detail. The ejection controller 312 controls an ink ejection operation in the ink-jet head 21, based on the elapsed time information of the ink. Here, the ejection operation control is to control a drive waveform to be formed by a drive voltage and voltage application time for the ink ejection operation of the ink-jet head 21.

Generally, the ink is ejected from the ejection ports in the ink-jet head 21 by applying the drive voltage to the ink-jet head 21. However, the amount of ink to be ejected varies depending on the ink viscosity. More specifically, the amount of ink to be ejected is reduced when the ink viscosity is high, and the amount of ink to be ejected is increased when the ink viscosity is low. Thus, as shown in FIG. 8A, the drive voltage set for the high-viscosity ink is larger than the drive voltage set for the low-viscosity ink.

Here, the ink viscosity decreases with time. Therefore, when the drive voltage for the high-viscosity ink is applied as it is, a high drive voltage is applied to the low-viscosity ink. As a result, an increase in ejection amount increases image density or an ejection failure such as transfer contamination occurs.

Therefore, the ejection controller 312 calculates the current ink physical property information based on the elapsed time information and adjusts the waveform of the drive voltage to be applied according to the calculated physical property information, thereby controlling the ejection operation. To be more specific, the ejection controller 312 first acquires the current date and time information from the timer 306 and calculates the time elapsed between the date of manufacture and the current date by referring to the elapsed time information. Then, based on the calculated elapsed time, the ejection controller 312 calculates the current ink physical property information by referring to temporal change information indicating a temporal change in physical properties.

In this embodiment, the temporal change information is information whose value is reduced with time, as in the case of the temporal change in ink. Therefore, the waveform of the drive voltage to be calculated by the ejection controller 312 turns out to be the waveform for the low ink viscosity shown in FIG. 8A. As described above, in this embodiment, even when the temporal change in ink reduces the viscosity, the drive voltage to be applied is reduced in response to the temporal change. Thus, the amount of ink to be ejected can be suppressed. As a result, image quality can be maintained by preventing the ejection failure.

Note that, here, the description is given of the case where the ink viscosity is reduced with time, as an example. However, the present invention is applicable by similarly adjusting the value of the drive voltage even when the ink viscosity is increased with time. In this case, there has heretofore been a problem that, as time passes after manufacture, the drive voltage for the low-viscosity ink is applied to the high-viscosity ink, resulting in reduction in ink ejection amount and thus reduction in image quality.

However, the value of the drive voltage can be gradually increased to correspond to the gradually increasing ink viscosity, by calculating the current ink physical property information based on the elapsed time information and calculating the drive voltage according to the calculated physical property information, as described above. Thus, since an optimum ink ejection amount is achieved, the ejection failure can be prevented and the image quality can be maintained.

Moreover, here, the description is given of the case where the drive voltage is adjusted in the drive waveform control for the ink ejection operation. However, the ink amount may be adjusted by changing the length of the voltage application time. Furthermore, although the drive voltage set based on the ink viscosity is adjusted here, a drive voltage set based on the volume elasticity of ink, density, specific weight (weight per unit volume) of ink, or the like may be used in the ink ejection control to adjust the drive voltage or the voltage application time according to the elapsed time information.

### (2) Control by Maintenance Controller

Next, description is given of control of maintenance condition parameters by the maintenance controller 313. Note that, here, description is given of purging processing of forcibly discharging ink from the ink-jet head 21 by increasing the pressure in the ink circulator 220.

The maintenance controller 313 performs control of the maintenance condition parameters concerning operations of the wiping unit or the purging mechanism, based on the current ink physical property information based on the elapsed time information. Generally, in the purging processing, ink required for ejection recovery is forcibly discharged from the nozzles by driving the positive pressure-side pressure regulating valve 252 and the like to increase the pressure in the ink circulator 220 to a predetermined pressure (hereinafter referred to as the purge pressure). However, the amount of ink to be ejected varies with the ink viscosity. More specifically, even with the same purge pressure, the amount of ink to be discharged from the nozzles is reduced when the ink viscosity is high, and the amount of ink to be discharged from the nozzles is increased when the ink viscosity is low. Thus, as shown in FIG. 8B, the purge (nozzle) pressure set for the high-viscosity ink is set larger than the purge (nozzle) pressure set for the low-viscosity ink.

Here, the ink viscosity decreases with time. Therefore, when the purge pressure for the high-viscosity ink is applied as it is, a high purge pressure is applied to the low-viscosity ink as time passes. As a result, an increase in amount of ink to be discharged causes unnecessary ink consumption. Furthermore, in the subsequent wiping processing, wiping is performed in a state where a large amount of ink remains on the ink ejection surface 211a. As a result, the ink remaining on the ink ejection surface 211a causes an ejection failure, leading to reduction in image quality.

Therefore, the maintenance controller 313 acquires the elapsed time information from the ink information accumulator 303a and calculates the current ink physical property information based on the acquired elapsed time information, thereby controlling the purge pressure that is one of the maintenance condition parameters, according to the calculated physical property information.

To be more specific, the maintenance controller 313 first acquires the current date and time information from the timer 306 and calculates the time elapsed between the date of manufacture and the current date by referring to the elapsed time information. Then, based on the calculated elapsed time, the maintenance controller 313 calculates the current ink physical property information by referring to temporal change information indicating a temporal change in physical properties.

In this embodiment, the temporal change information is information that the viscosity is reduced with time, as in the case of the temporal change in ink. Therefore, the waveform of the purge pressure to be calculated by the maintenance controller 313 turns out to be the waveform of the purge pressure for the low ink viscosity shown in FIG. 8B. As described above, in this embodiment, even when the temporal change in ink reduces the viscosity, the purge pressure is reduced in response to the temporal change. Thus, the amount of ink to be ejected can be suppressed for ejection recovery, and the ink remaining on the ink ejection surface 211a can be prevented from causing an ejection failure.

Note that, here, the description is given of the case where the ink viscosity is reduced with time, as an example. However, the present invention is applicable by similarly controlling the purge pressure even when the ink viscosity is increased with time. In this case, there has heretofore been a problem that, as time passes after manufacture, the purge pressure for the low-viscosity ink is applied to the high-viscosity ink. As a result, the amount of ink to be discharged is reduced and a foreign object inside the nozzles cannot be pushed out, leading to deterioration in ejection recovery. Meanwhile, the ink ejection surface 211a is damaged by wiping in a state where a small amount of ink remains on the ink ejection surface 211a.

However, the value of the purge pressure can be gradually increased to correspond to the gradually increasing ink viscosity, by calculating the current ink physical property information based on the elapsed time information and controlling the purge pressure according to the calculated physical property information, as described above. As a result, the foreign object inside the nozzles can be properly pushed out by discharging an optimum amount of ink. At the same time, the ink ejection surface 211a can be prevented from being damaged, and thus the ejection recovery can be maintained.

Moreover, here, the description is given of the control of regulating the purge pressure, as the control of the maintenance condition parameter. However, the control may be performed using other maintenance condition parameters. To be more specific, the control of the maintenance condition parameters includes adjustment of a pressurization time period for ink ejection or suction and operation frequency, operation speed and the number of operations of the wiping unit, besides control of the pressure for ink ejection or suction by the purging mechanism. The maintenance controller 313 can make adjustment using at least one of the above or a combination thereof.

In the case of controlling the pressurization time period, for example, when the ink viscosity is reduced with time, the amount of ink to be discharged from the nozzles is optimized by calculating the current ink physical property information based on the elapsed time information and reducing the pressure application time. On the other hand, when the ink viscosity is increased with time, the amount of ink to be discharged from the nozzles is optimized by increasing the pressure application time based on the elapsed time information.

Furthermore, here, the maintenance condition parameter set based on the ink viscosity is adjusted. However, in the maintenance control, maintenance condition parameters set based on ink surface tension and the like may be used, and these maintenance condition parameters may be adjusted according to the elapsed time information.

When the ink surface tension is high, for example, the timing of the ink starting to be ejected when the purge pressure is applied is delayed. Thus, the amount of ink to be discharged from the nozzles, which is required for ejection recovery, is reduced. On the other hand, when the ink surface tension is low, the timing of the ink starting to be ejected when the purge pressure is applied is quickened. Thus, the amount of ink to be discharged from the nozzles, which is required for ejection recovery, is increased. As a result, the same problem as that of the ink viscosity described above occurs. However, as described above, the ejection recovery can be maintained by calculating the current ink physical property information according to the elapsed time information and optimizing the purge pressure or the purge time for the ink surface tension. To be more specific, when the ink surface tension decreases with time, the purge pressure for the ink having high surface tension is applied to the ink having low surface tension. As a result, there is a problem that an increase in the amount of ink to be discharged leads to unnecessary ink consumption. However, the purge pressure can be reduced and an optimum amount of ink can be discharged by calculating the current ink physical property information according to the elapsed time information and controlling the purge pressure according to the calculated physical property information. Thus, the ejection recovery can be maintained.

On the other hand, when the ink surface tension increases with time, the purge pressure for the ink having low surface tension is applied to the ink having high surface tension. As a result, there is a problem that the foreign object inside the nozzles cannot be pushed out due to reduction in the amount of ink to be discharged and the ejection recovery is deteriorated. However, the purge pressure can be increased and an optimum amount of ink can be discharged by calculating the current ink physical property information according to the elapsed time information and controlling the purge pressure according to the calculated physical property information. Thus, the ejection recovery can be maintained.

### (3) Control by Ink Circulation Controller

Next, description is given of ink circulation control in the ink circulator 220. The ink circulation controller 311 controls circulation condition parameters in the ink circulator 220 based on the current ink physical property information based on the acquired elapsed time information. Note that, here, as for control of the circulation condition parameters, description is given of control of a pressure when ink is circulated by being sent from the positive-pressure tank 221 to the ink-jet head 21 and then to the negative-pressure tank 224. During this control, the positive pressure-side pressure regulating valve 252, the negative pressure-side pressure regulating valve 256 and the like in the pressure regulator 240 are driven, besides the air pump 259.

Generally, in order to normally eject ink from the ink-jet head 21, the pressure (nozzle pressure) applied to the nozzles in the ink-jet head 21 needs to be maintained at an appropriate pressure by controlling the ink circulator 220 and the pressure regulator 240. However, the pressure to be applied varies with the ink viscosity.

Here, since the ink viscosity decreases with time, when pressure application is performed to obtain a nozzle pressure for the high-viscosity ink, the nozzle pressure of the ink-jet head 21 is reduced as time passes. As a result, air sucked in through the nozzles causes an ejection failure.

Therefore, the ink circulation controller 311 calculates the current ink physical property information based on the elapsed time information, and controls the pressures in the positive-pressure tank 221 and the negative-pressure tank 224, which are the circulation condition parameters, according to the calculated current physical property information.

To be more specific, the ink circulation controller 311 first acquires the current date and time information from the timer 306 and calculates the time elapsed between the date manufacture and the current date by referring to the elapsed time information. Then, based on the calculated elapsed time, the ink circulation controller 311 calculates the current ink physical property information by referring to temporal change information indicating a temporal change in physical properties.

In this embodiment, the temporal change information indicating the temporal change in physical properties is information that the viscosity is reduced with time, as in the case of the temporal change in ink. Therefore, the ink circulation controller 311 calculates a value that increases the pressures in the positive-pressure tank 221 and the negative-pressure tank 224, to obtain an appropriate nozzle pressure for the low-viscosity ink.

As described above, in this embodiment, even when the viscosity is reduced by a temporal change in ink, the pressures in the positive-pressure tank 221 and the negative-pressure tank 224 are regulated in response to the temporal change. Thus, air can be prevented from being sucked in through the nozzles, and therefore, the ejection failure can be prevented.

Note that, here, the description is given of the case where the ink viscosity is reduced with time, as an example. However, the present invention is applicable by similarly adjusting the circulation condition parameter and regulating the pressures in the positive-pressure tank 221 and the negative-pressure tank 224 even when the ink viscosity is increased with time. In this case, there has heretofore been a problem that, as time passes after manufacture, the nozzle pressure of the ink-jet head 21 containing the high-viscosity ink is increased, causing the ink to overflow from the nozzles and deteriorating the image quality.

However, the pressures in the tanks can be gradually reduced to correspond to the gradually increasing ink viscosity, by calculating the current ink physical property information based on the elapsed time information and controlling the nozzle pressure according to the calculated physical property information. As a result, the ink can be prevented from overflowing from the nozzles, and thus the ejection failure can be prevented.

Moreover, here, the description is given of the example where the nozzle pressure is used as the circulation condition parameter and the nozzle pressure is regulated. However, for example, the nozzle pressure may be used as the circulation condition parameter to regulate a pressure difference between the negative-pressure tank and the positive-pressure tank. Alternatively, a flow rate of ink to be circulated may be used as the nozzle circulation condition parameter, and the flow rate of the ink to be circulated may be controlled.

### Drive Control Operation During Ink Replacement

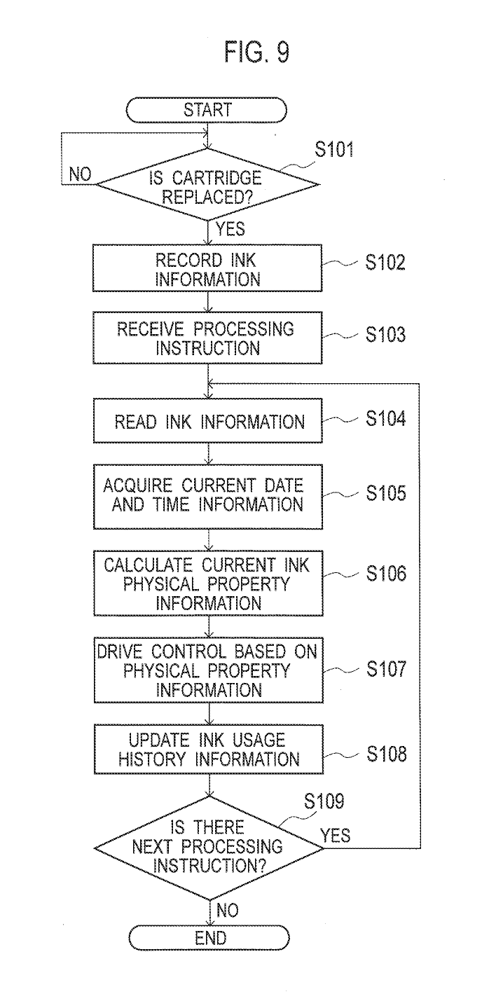

Next, a drive control operation during ink replacement is described. FIG. 9 is a flowchart showing the drive control operation during ink replacement according to this embodiment. First, the arithmetic processor 3 determines, based on the attachment detection sensor or the like, whether or not a new cartridge 24 is attached (S101). Here, when the new cartridge 24 is not attached (“N” in S101), the arithmetic processor 3 stands by until the attachment is detected.

When the new cartridge 24 is attached (“Y” in S101), the cartridge information acquirer 302 reads ink information from the storage tag 24a in the cartridge 24 through the contactless communication interface 301, and records the ink information in the ink information accumulator 303a (S102). Also, the cartridge information acquirer 302 transmits ink replacement information to any of the controllers 311 to 313 in the drive controller 310.

Thereafter, the arithmetic processor receives an instruction to execute print processing or maintenance processing (S103). Here, upon receipt of a print execution instruction, the image processor 305 performs digital signal processing dedicated to image processing, and transmits image data to the drive controller 310. On the other hand, upon receipt of a maintenance instruction, such information is inputted directly to the maintenance controller 313.

The drive controller 310 adjusts drive controls corresponding to the respective controllers. To be more specific, the ink information such as ink physical property information and elapsed time information is read from the ink information accumulator 303a (S104). Furthermore, the controllers 311 to 313 acquire the current date and time information from the timer 306 (S105).

Then, the controllers 311 to 313 calculate elapsed time information on the time elapsed since manufacture based on information that enables calculation of time elapsed since manufacture and the current date and time information, and calculate the current ink physical property information based on the calculated elapsed time information (S106). Then, controls by the respective controllers are adjusted according to the calculated physical property information, thus performing drive control (S107). To be more specific, the ejection controller 312 controls an ink ejection operation in the ink-jet head 21, the maintenance controller 313 controls maintenance condition parameters concerning operations of the wiping unit 43 or the purging mechanism, and the ink circulation controller 311 controls circulation condition parameters. After the drive control, ink usage history information such as the amount of ink used (amount of ink in the ink circulator 220) is recorded in the storage 303 (S108).

When there is a next processing instruction (“Y” in S109), the controllers 311 to 313 calculate the current ink physical property information based on the elapsed time information also for the next and subsequent processing, thereby controlling the controllers (S104 to S109). On the other hand, when there is no next processing instruction (“N” in S109), the control by the controllers 311 to 313 is terminated.

### Advantageous Effects

As described above, according to this embodiment, the controllers 311 to 313 in the drive controller 310 hold elapsed time information on time elapsed since manufacture of ink stored in the ink cartridge 24, thereby controlling the controllers based on the elapsed time information. To be more specific, the controllers 311 to 313 calculate current ink physical property information based on the elapsed time information, and control the ejection operation during ink replacement, the maintenance condition parameters and the circulation condition parameters according to the calculated physical property information. Thus, when an increase in ink viscosity with time makes it difficult for the ink to be ejected from the nozzles, the ejection amount can be increased by controlling the controllers. On the other hand, when reduction in ink viscosity with time makes it easier for the ink to be ejected from the nozzles, the ejection amount can be suppressed by controlling the controllers. Thus, according to this embodiment, the ejection operation can be optimized in response to a temporal change in ink, and the image quality can be maintained by preventing the ejection failure.

Moreover, in the ejection operation control according to this embodiment, the drive waveform is controlled, which is formed based on the drive voltage and the voltage application time for the ink ejection operation by the ink-jet head 21. Thus, optimum ejection control can be executed according to the current ink physical properties based on the elapsed time information. As a result, the image quality can be maintained by further preventing the ejection failure and deterioration in ejection recovery.

Furthermore, in this embodiment, the control of the maintenance condition parameters includes control of the pressure or time for ink ejection or suction by the purging mechanism or adjustment of at least one of operation frequency, operation speed and the number of operations of the wiping unit 43. Thus, the control can be performed by appropriately selecting the optimum maintenance condition parameter according to the current ink physical properties based on the elapsed time information. As a result, the image quality can be maintained by further preventing the ejection failure and deterioration in ejection recovery.

Moreover, in this embodiment, the control of the circulation condition parameter includes regulation of the pressure when the ink is circulated by being sent from the positive-pressure tank 221 to the ink-jet head 21 and then to the negative-pressure tank 224 or control of the flow rate of the ink to be circulated. Thus, the control can be performed by appropriately selecting the optimum ink circulation parameter according to the current ink physical properties based on the elapsed time information. As a result, the image quality can be maintained by further preventing the ejection failure and deterioration in ejection recovery.

Furthermore, in this embodiment, the ink physical property information includes at least one of viscosity, volume elasticity, surface tension, density and specific weight of ink of each color. Thus, the controllers 311 to 313 can be controlled by appropriately selecting each item to be affected by the ink physical properties. As a result, the image quality can be maintained by further preventing the ejection failure and deterioration in ejection recovery.

Note that, although the ink-jet printer 100 is described in this embodiment, the present invention is also applicable to other types of printers that perform printing while conveying a printing medium.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. An ink-jet printer comprising:
an ink cartridge attachment unit;
an ink cartridge attachable to and detachable from the ink cartridge attachment unit, and configured to store ink to be fed to the ink-jet printer and store elapsed time information on a time elapsed since manufacture of the stored ink;
an ink-jet head having a nozzle and configured to eject the ink stored in the ink cartridge through the nozzle and form an image on a paper; and
a processor configured to acquire the elapsed time information held by the ink cartridge loaded in the ink cartridge attachment unit, calculate current ink physical property information based on the acquired elapsed time information, and control an ink ejection operation by the ink-jet head based on the calculated physical property information.

2. The ink-jet printer according to claim 1, wherein the processor controls a drive waveform formed by a drive voltage and a voltage application time for the ink ejection operation by the ink-jet head upon control of the ejection operation.

3. An ink-jet printer comprising:
an ink cartridge attachment unit;
an ink cartridge attachable to and detachable from the ink cartridge attachment unit, and configured to store ink to be fed to the ink-jet printer and store elapsed time information on a time elapsed since manufacture of the stored ink;
an ink-jet head having a nozzle and configured to eject the ink stored in the ink cartridge through the nozzle and form an image on a paper;
a wiping unit configured to slide on an ink ejection surface of the ink-jet head and remove ink adhering to the ink ejection surface;
a purging mechanism configured to remove, by ejection and suction, ink inside an ink ejection port of the nozzle; and
a processor configured to acquire the elapsed time information held by the ink cartridge loaded in the ink cartridge attachment unit, calculate current ink physical property information based on the acquired elapsed time information, and control a maintenance condition parameter concerning an operation of the wiping unit or the purging mechanism based on the calculated physical property information.

4. The ink-jet printer according to claim 3, wherein the maintenance condition parameter includes at least one of pressures and time periods for ink ejection and suction by the purging mechanism, and an operation frequency, an operation speed and the number of operations by the wiping unit.

5. An ink-jet printer comprising:
an ink cartridge attachment unit;
an ink cartridge attachable to and detachable from the ink cartridge attachment unit and configured to store ink to be fed to the ink-jet printer and store elapsed time information on a time elapsed since manufacture of the stored ink;
a supply tank provided in a main body of the ink-jet printer and configured to receive the ink stored in the ink cartridge and store ink including the received ink;
an ink-jet head having a nozzle and configured to eject the ink stored in the supply tank through the nozzle and form an image on a paper;
a pipe for supplying the ink stored in the ink cartridge to the supply tank;
a circulation path for circulating the ink between the supply tank and the ink-jet head; and
a processor configured to acquire the elapsed time information held by the ink cartridge loaded in the ink cartridge attachment unit, calculate current ink physical property information based on the acquired elapsed time information, and control a circulation condition parameter in the circulation path based on the calculated physical property information.

6. The ink-jet printer according to claim 5, wherein the circulation condition parameter includes a pressure for circulating the ink by sending the ink from the supply tank to the ink-jet head and then from the ink-jet head to the supply tank, or a flow rate of the ink circulated.

7. The ink-jet printer according to claim 1, wherein the current ink physical property information based on the elapsed time information includes at least one of an ink viscosity, a volume elasticity, a surface tension, a density, or a specific weight of the ink.

8. The ink-jet printer according to claim 3, wherein the current ink physical property information based on the elapsed time information includes at least one of an ink viscosity, a volume elasticity, a surface tension, a density, or a specific weight of the ink.

9. The ink-jet printer according to claim 5, wherein the current ink physical property information based on the elapsed time information includes at least one of an ink viscosity, a volume elasticity, a surface tension, a density, or a specific weight of the ink.

10. An ink cartridge comprising:
a main body configured to house ink therein to be fed to an ink-jet printer, the main body being attachable to and detachable from the ink-jet printer; and
a storage configured to store elapsed time information on a time elapsed since manufacture of the housed ink such that the elapsed time information is readable from the ink-jet printer.
